(19) United States
(12) Patent Application Publication
(10) Pub. No.: US 2006/0132106 A1
(43) Pub. Date: Jun. 22, 2006

(54) System and method for regenerative burn-in

(76) Inventors: Michael Lucas, Irvine, CA (US); Eric Gilbert, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/287,580

(22) Filed: Nov. 23, 2005

Related U.S. Application Data
(60) Provisional application No. 60/630,873, filed on Nov. 24, 2004.

(51) Int. Cl. G05F 1/577

(52) U.S. Cl. 323/267

(57) ABSTRACT

A regenerative load that includes an input configured to draw a specified current and an output configured to provide an output voltage and current is described. The regenerative load configured to maintain the output voltage to cause the regenerative load to draw the specified current from the unit under test. The output of the regenerative load is provided back to the input of the unit under test. The input current or voltage can be AC, DC, or a combination of AC and DC. The output current or voltage can be AC, DC, or a combination of AC and DC. In one embodiment, a thermal barrier is provided between a test chamber and a load chamber to allow converters under test to be operated at a test temperature while the regenerative loads are operated at a desired operational temperature.

### REFERENCE TO RELATED APPLICATION

The present application claims priority benefit of U.S. Provisional Application No. 60/630,873, filed Nov. 24, 2004, titled SYSTEM AND METHOD FOR REGENERATIVE BURN-IN, the entire contents of which is hereby incorporated by reference.

### BACKGROUND OF THE INVENTION

1. Field of the Invention

The invention relates to a system and method for regenerative burn-in of electronic power supplies, DC-to-DC converters, and the like.

2. Description of the Related Art

It is common practice to use resistive loads for burn-in testing of power supplies, DC-to-DC converters, and the like. Power applied to the resistive loads is dissipated as heat. Because the dissipated heat is not employed for any useful purpose, the dissipated power is wasted. In many cases, additional power is wasted because the dissipated heat increases the loads on the air conditioning systems used to cool the buildings that house the systems under test.

### SUMMARY

The present invention solves these and other problems by regeneratively loading a power supply, DC-to-DC converter, or other such device under test, such that at least a portion of the output power from the device under test is provided back to the input of the device under test.

In one embodiment, the regenerative load includes an input configured to draw a specified current and an output configured to provide an output voltage and current. The regenerative load configured to maintain the output voltage to cause the regenerative load to draw the specified current from the unit under test. The output of the regenerative load is provided back to the input of the unit under test. The input current or voltage can be AC, DC, or a combination of AC and DC. The output current or voltage can be AC, DC, or a combination of AC and DC.

In one embodiment, DC isolation is provided between the input and output of the regenerative load.

In one embodiment, the regenerative load includes a command input configured to receive commands. In one embodiment, the input current is programmable. In one embodiment, the output voltage is limited to an upper limit. In one embodiment, the output upper limit is programmable. In one embodiment, the regenerative load includes a second input configured to draw a specified second current and/or voltage.

In one embodiment, one or more regenerative loads are provided to a load chamber and one or more devices under test are provided to a test chamber. The regenerative loads are provided to the devices under test. A thermal barrier is provided between the load chamber and the test chamber to allow the two chambers to be operated at different temperatures. In one embodiment, an air recirculation system is provided to allow air to be recirculated in the test chamber so that the test chamber can be economically operated at an elevated temperature.

### BRIEF DESCRIPTION OF THE DRAWINGS

FIG. 1 shows a conventional burn-in system.

FIG. 2 shows a converter with a single output configured to drive a regenerative load with a single input.

FIG. 3 shows a system where a dual-output converter is provided to first and second regenerative loads.

FIG. 4 shows an alternative embodiment wherein the outputs from the dual-output converter are provided to respective inputs of a dual-input regenerative load.

FIG. 5 shows an alternative embodiment wherein the outputs from two single-output converters are provided to respective inputs of a dual-input regenerative load.

FIG. 6 (consisting of FIGS. 6A and 6B) is a schematic diagram of one embodiment of the regenerative load.

FIG. 7 is a block diagram of one embodiment of a DC-isolated regenerative load.

FIG. 8 is a schematic diagram of one implementation of a DC-isolated regenerative load.

FIG. 9 shows one embodiment of a system for testing multiple converters using regenerative loads and for providing a thermal barrier between the converters under test and the regenerative loads.

FIG. 10A shows one embodiment of a card mounting arrangement for use in connection with the test system of FIG. 9 wherein a plurality of cards are provided to connectors on an electrical backplane.

FIG. 10B shows one embodiment of a card mounting arrangement for use in connection with the test system of FIG. 9 wherein a connector provided to the regenerative loads mate with connectors provided to the converters under test.

FIG. 11 shows one embodiment of an airflow system for providing temperature control of a load chamber and a test chamber.

FIG. 12 shows one embodiment of an airflow system for providing temperature control of a load chamber and a test chamber wherein energy air is re-circulated around the test chamber.

FIG. 13 shows one embodiment of an airflow system for providing temperature control of a load chamber and a test chamber wherein energy air is re-circulated within.

### DETAILED DESCRIPTION OF THE PREFERRED EMBODIMENT

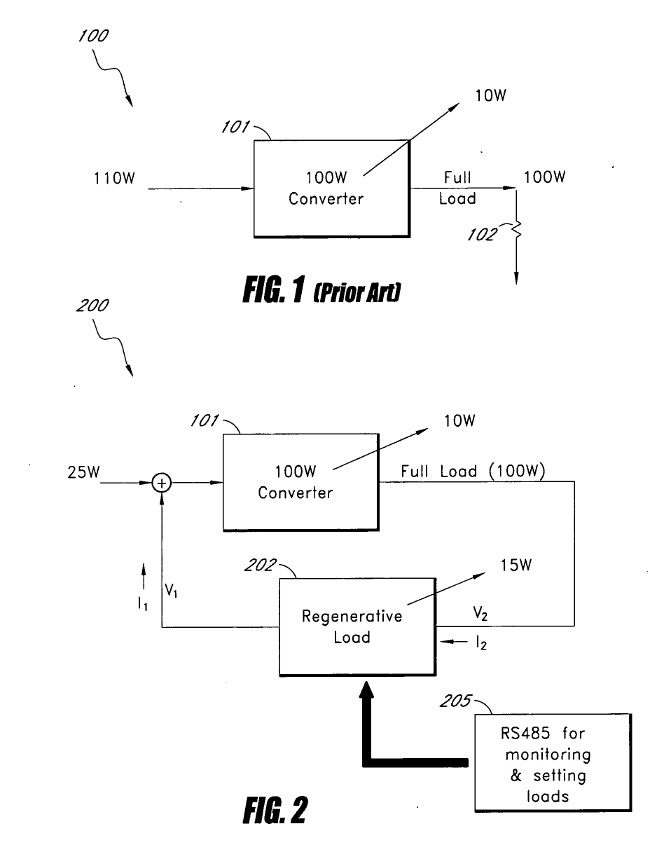

FIG. 1 shows a conventional burn-in system 100. In the system 100, power is provided to a converter 101 under test. Output power from the converter 101 is provided to a load resistor 102 that dissipates the output power from the converter 101 as heat. In FIG. 1, all of the power provided to the converter 101 is dissipated as heat. For example, if the converter 101 provides 100 watts of output power at 90% efficiency, then a total of 110 watts is dissipated during burn-in (10 watts in the converter 101, and 100 watts in the resistor 102).

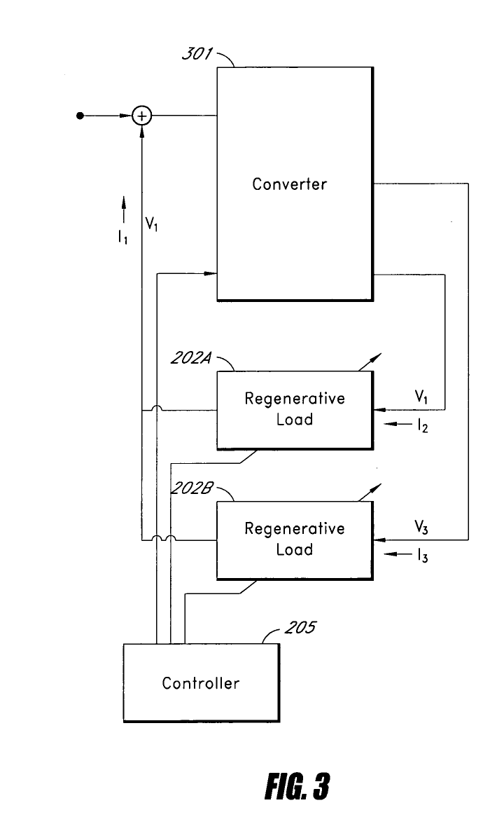

FIG. 2 shows a regenerative burn-in system 200. In the system 200, output power from the converter 101 is provided to an input of a regenerative load 202. The converter 101 is configured to receive an input voltage V₁ and provide an output voltage V₂. The regenerative load 202 receives power from the converter 101 at a specified voltage V₂ and current I₂, and provides power back to the converter 101 at the voltage V₁ and a current I₁. The regenerative load 202 converts the power represented by V₂I₂ to the power represented by V₁I₁. The power V₁I₁ is less than the power V₂I₂ by an amount corresponding to the efficiency of the regenerative load 202. In one embodiment, the regenerative load 202 operates at an efficiency of at least 80 percent. The current I₁ can be direct current (DC) or alternating current (AC). If the current 12 is DC and the current I₁ is AC, the regenerative load 202 converts DC to AC.

In one embodiment, the regenerative load 202 is configured to draw a specified input current I₂ (corresponding to a desired output current of the converter 101 under test). The regenerative load 202 increases its output voltage V₁ until the power provided to the regenerative load 202 is equal to the power output of the regenerative load 202 minus the internal losses in the regenerative load 202. In one embodiment, the desired input current I₂ is programmable. In one embodiment, the maximum output voltage V₁ is programmable. Limiting the maximum output voltage V₁ is provided to protect the converter 101 from excessive input voltages. Thus, unlike a regulated supply which typically has a regulated output, the regenerative load 202 has a regulated input. Within its operating limits, the regenerative load 202 is configured to draw a regulated current (regardless of the input voltage) and increase its output voltage as necessary to dump the power drawn by the input. The regenerative load 202 can operate with a variety of input and output currents and voltages.

In one embodiment, a controller 205 is provided to control the regenerative load 202 to provide a desired test regimen for the converter 101. The controller 205 can program the desired current 12 and the maximum voltage V₁. The controller 205 can communicate with the regenerative load 205 using wired communication (e.g., RS485, RS232, Ethernet, firewire, etc.) or by wireless communication. The controller 205 controls the testing of the converter 101 by controlling the amount of current I₂ drawn by the regenerative load 202. Thus, the controller 205 can vary the power delivered by the converter 101, and thereby, test the converter at various load conditions. In one embodiment, the regenerative load 202 measures one or more of the actual voltages and currents (e.g., V₁, I₁, V₂, and/or I₂) and reports the measured values to the controller 205. In one embodiment, the regenerative load 202 also reports diagnostic information (e.g., internal temperature, self-test information, etc.) to the controller 205. In one embodiment, the regenerative load 202 provides automatic data logging and fault protection.

The regenerative load 202 increases or decreases the output voltage of the converter 202 to allow output power from the converter 101 to be fed back to the input of the converter 101, thereby, substantially reducing the dissipated power (and the input power) required to test the converter 101. Since the load current is programmable, and includes read-back capability, the regenerative load 202 can be computer-controlled and cover a wide range of converters. In contrast to the system 100, the power dissipated in the system 200 is the internal power dissipated in the converter 101 (based on its efficiency) and the power dissipated in the regenerative load 202 (due to the efficiency of the regenerative load). The input power provided to the system 200 is the power used to make up for the power dissipated in the converter 101 and the regenerative load 202. For example, if the converter (at 90% efficiency) provides 100 watts of output power to the regenerative load, and the regenerative load dissipates 15 watts (corresponding to 85 percent efficiency), then the input power is 25 watts. This represents a considerable power saving over the system 100 where the same burn-in test of the converter 101 consumed 110 watts.

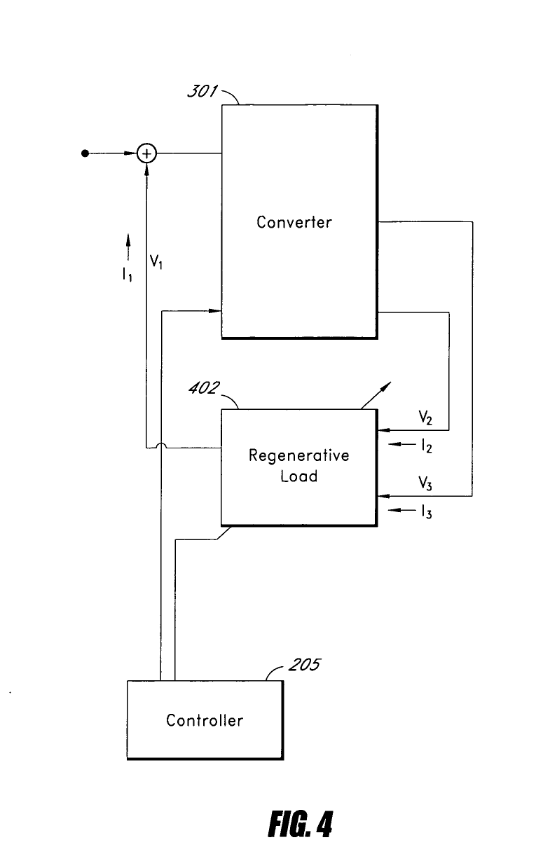

FIG. 2 shows a converter with a single output configured to drive a regenerative load 202 with a single input. FIG. 3 shows a system where a dual-output converter 301 provides an output V₂I₂ and an output V₃I₃. The first output V₂I₂ is provided to a first regenerative load 202A, and the second output V₂I₂ is provided to a second regenerative load 202B. The outputs of the regenerative loads 202A and 202B are combined to produce the voltage V₁ and the current I₁. In one embodiment, the outputs of the regenerative loads 202A and 202B are combined in series to produce the voltage V₁ and the current I₁. In one embodiment, the outputs of the regenerative loads 202A and 202B are combined in parallel to produce the voltage V₁ and the current I₁.

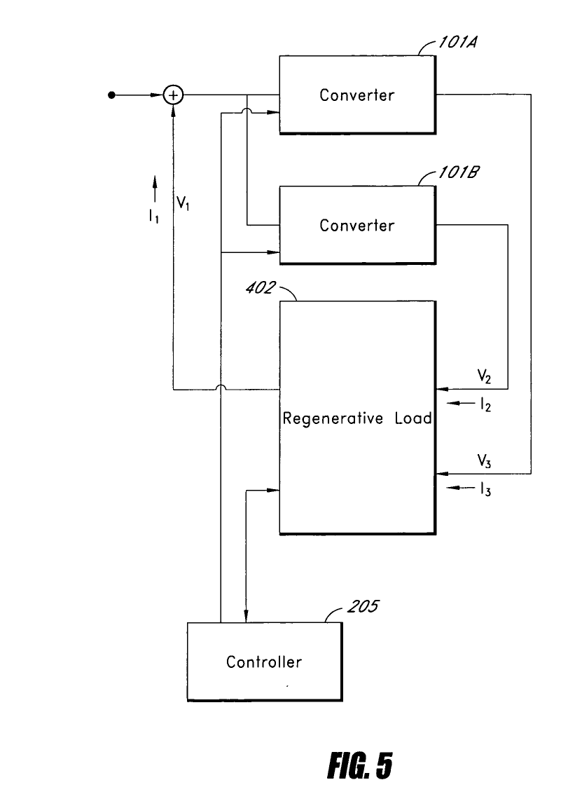

FIG. 4 shows an alternative embodiment wherein the outputs V₂I₂ and V₃I₃ from the converter 301 are provided to respective inputs of a dual-input regenerative load 402. The dual-input regenerative load 402 produces the voltage V₁ and the current I₁. In one embodiment, desired load currents I₂ and I₃ are separately programmable in the dual-input regenerative load 402. In one embodiment, the dual input regenerative load 402 is configured to measure one or more of the actual voltages and currents (e.g., V₁, I₁, V₂, I₂, V₂, I₃) and report the measured values to the controller 205.

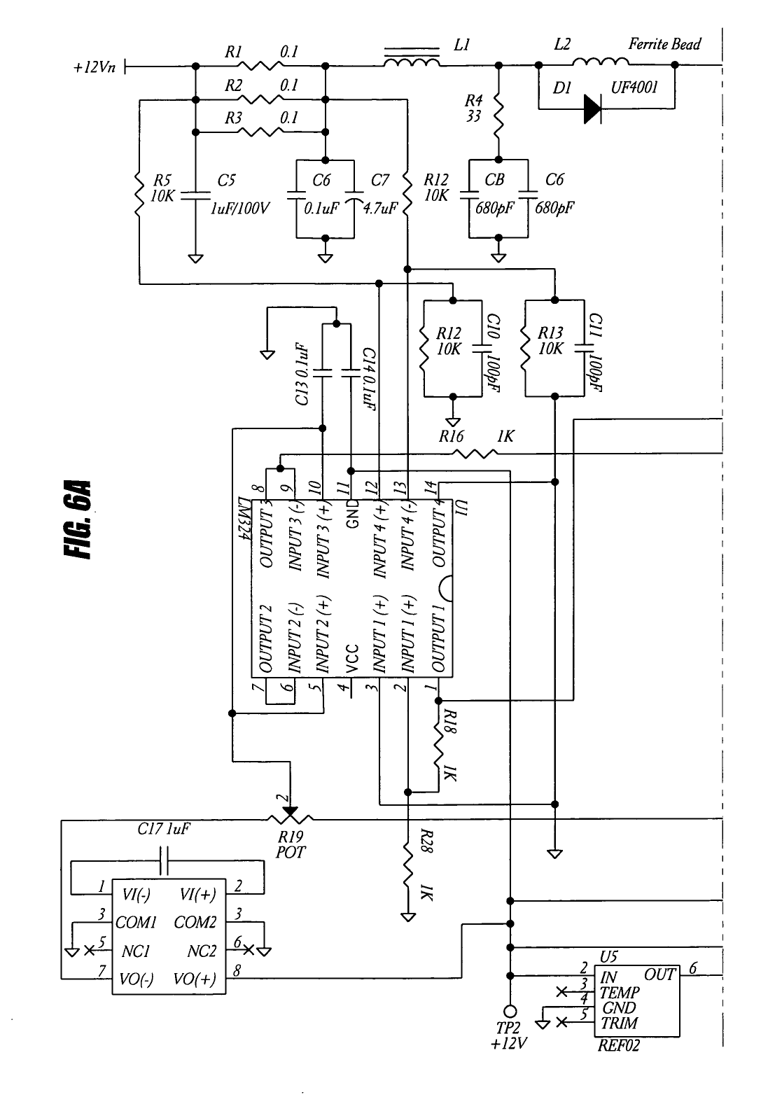

FIG. 5 shows an alternative embodiment wherein the outputs V₂I₂ and V₃I₃ from respective single-output converters 101A and 101B are provided to respective inputs of a dual-input regenerative load 402. The dual-input regenerative load 402 produces the voltage V₁ and the current I₁, which are then provided to the inputs of the converters 101A and 101B.

One of ordinary skill in the art will recognize that the techniques shown in FIGS. 3-5 can be extended to converters with more than two outputs and/or to converters with more than two inputs. One of ordinary skill in the art will further recognize that the outputs from one or more converters can be combined in series and/or parallel and provided to a regenerative load such that a single regenerative load can be used to test a number of converters.

In one embodiment, the controller 205 produces a report of test results. In one embodiment, the system 205 uses email to send one or more of, status reports, error reports, test results, etc.

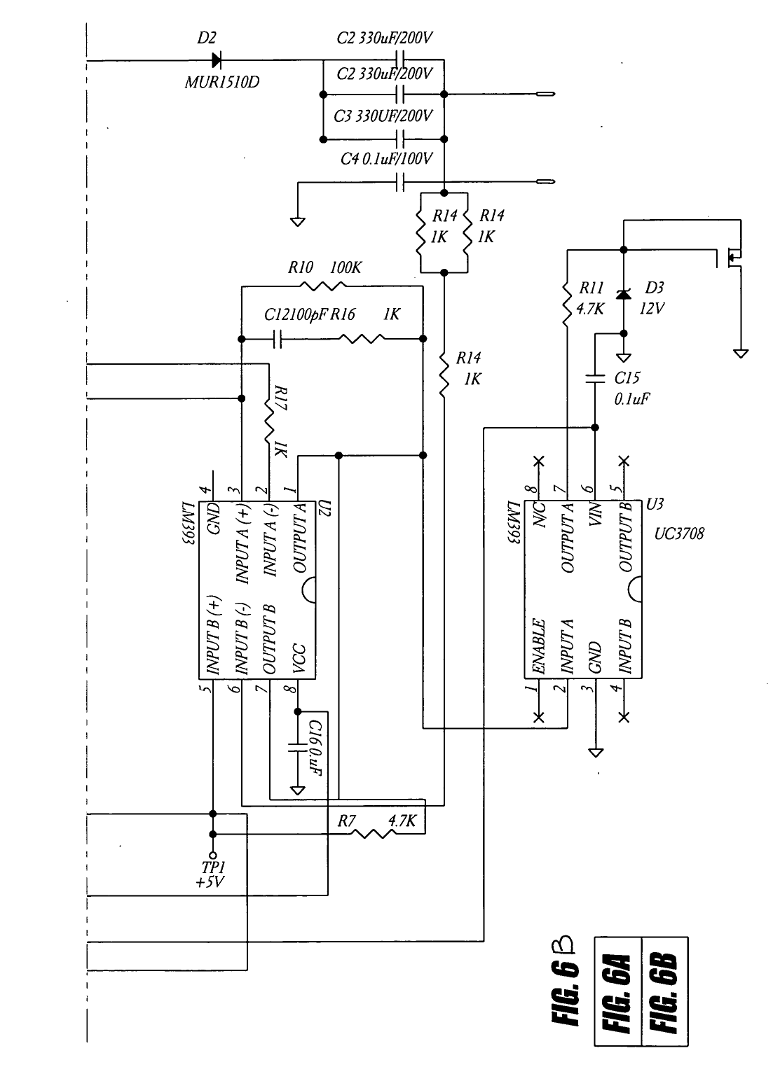

FIG. 6 (consisting of FIGS. 6A and 6B) is a schematic diagram of one embodiment of the regenerative load. The system shown in FIG. 6 is configured to operate with converters with input ranges from 3-15 volts DC and outputs from 1.2-15 volts DC.

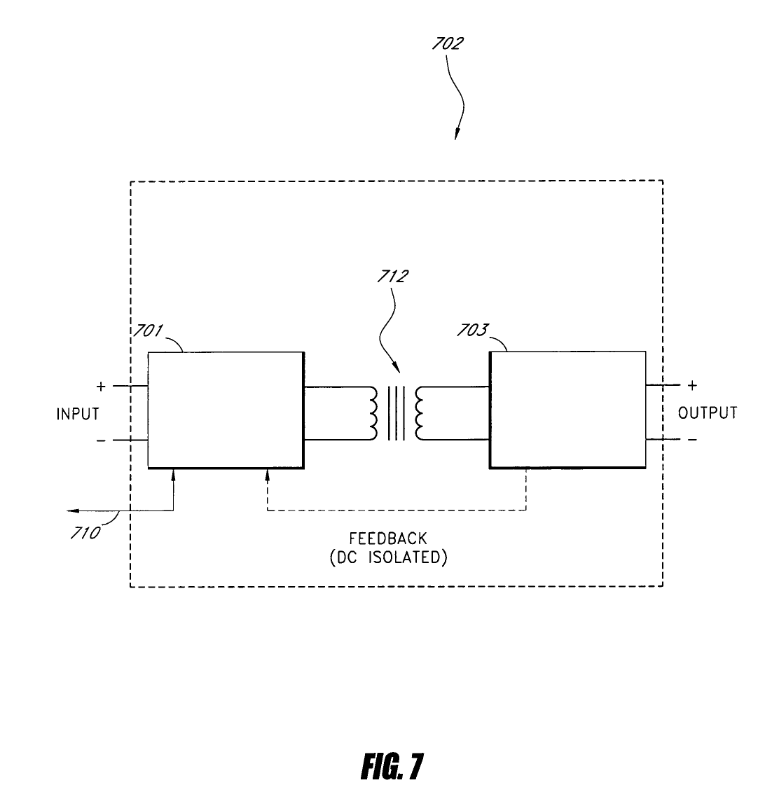

FIG. 7 is a block diagram of a DC-isolated regenerative load 702. In the DC-isolated load 702, input power from the converter under test is provided to an input module 701. The input module 701 converts the input power (AC or DC) into an AC waveform at a desired frequency. The AC waveform is provided to one or more primary windings of a transformer 712. One or more output windings of the transformer 712 are provided to an output module 703. In one embodiment, the output module 703 performs AC to DC conversion and filtering to produce a DC output. In one embodiment DC-isolated feedback 704 is provided from the output module 703 to the input module 701. In one embodiment, the feedback 704 is electrically isolated by using optical coupling through an opti-isolator. In one embodiment, the feedback 704 is DC-isolated by using a feedback transformer and/or capacitor. In one embodiment a computer control bus 710 is provided to the DC-isolated load 702 to allow for control and/or monitoring of the DC-isolated load (e.g., current, voltage, etc.) as described, for example, in connection with the generic regenerative load 202. The control bus can be a communications bus, such as, for example, RS485, Ethernet, USB, etc.

The DC-isolated regenerative load 702 provides DC isolation between the input and output of the regenerative load 702. The use of DC-isolation allows the regenerative load 702 to be used with converters that provide positive outputs, negative outputs, or both.

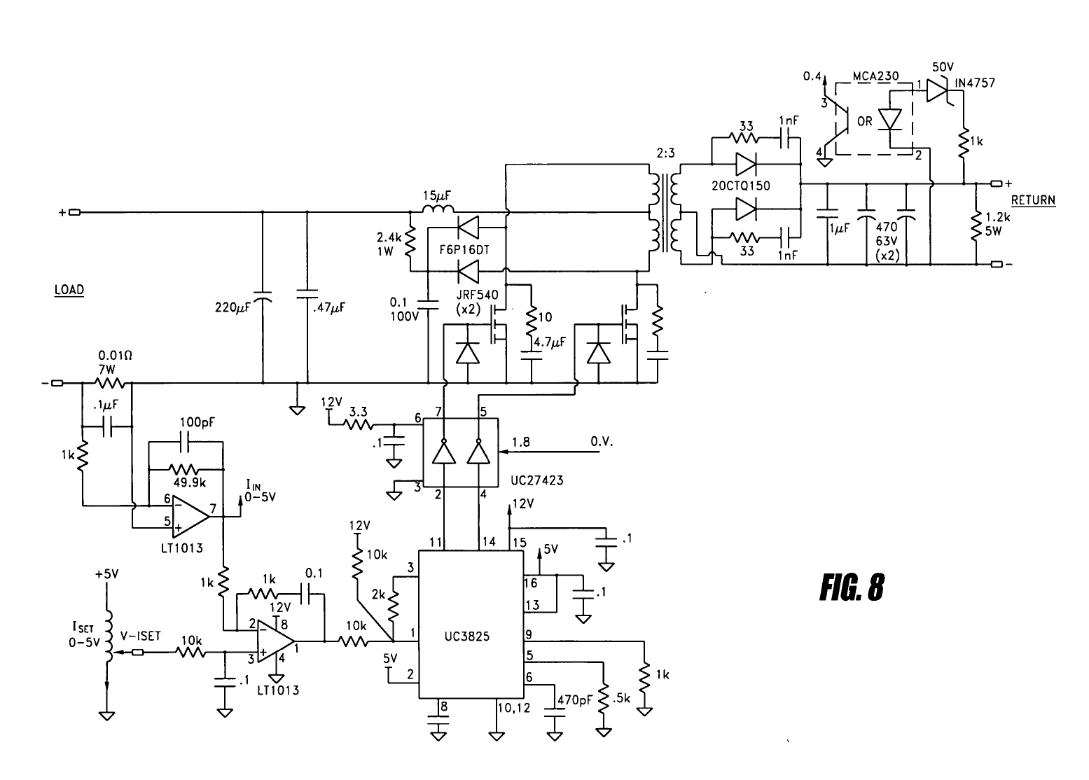

FIG. 8 is a schematic diagram of one implementation of the DC-isolated regenerative load 702. The circuit shown in FIG. 8 is but one example of a DC-isolated regenerative load, and that various other embodiments will be within the skill of one of ordinary skill in the art.

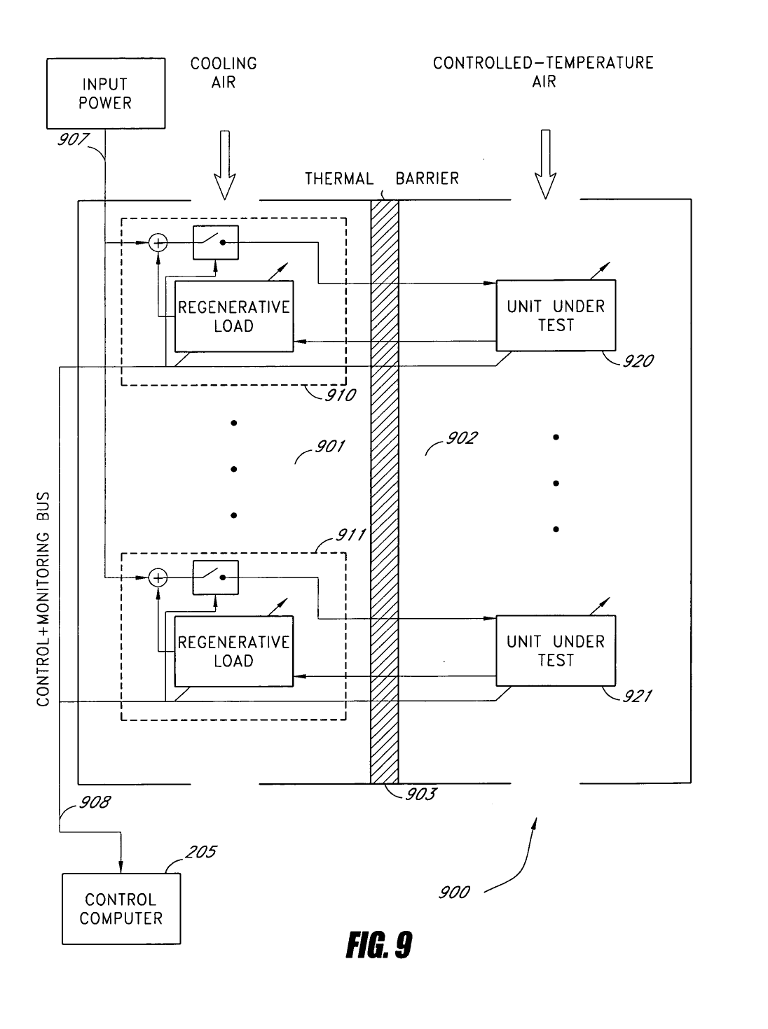

FIG. 9 shows one embodiment of a system 900 for testing multiple converters using regenerative loads and for providing a thermal barrier 903 between the converters under test and the regenerative loads. In the system 900, a plurality of regenerative load modules 910-911 are provided to a load chamber 901. A plurality of converters 920-921 (converters under test) are provided to a test chamber 902. A thermal barrier 903 is provided between the load chamber 901 and the test chamber 902 to allow the temperatures of the load chamber 901 and the test chamber 902 to be independently controlled. Input power is provided to the regenerative load modules 910-911. The controller 205 is also provided to the regenerative load modules 910-911 and, optionally, to the converters 920-921.

In one embodiment, the regenerative load modules 910-911 include test circuitry, such as, for example, analog-to-digital converters to allow the operation of the converters to be monitored by the controller 205. In one embodiment, the regenerative load modules 910-911 include circuitry to allow the controller 205 to monitor the input voltage and/or current to the converters. In one embodiment, the regenerative load modules 910-911 include circuitry to allow the controller 205 to monitor the output voltage and/or current to the converters.

In one embodiment, each converter under test is provided to separate a regenerative load. Such an arrangement allows each unit under to test to be separately controlled and monitored. In one embodiment, each regenerative load module 910-911 in separately controllable by the controller 205. In one embodiment, each regenerative load module 910-911 includes a switch (controlled by the controller 205) to provide power to a unit under test.

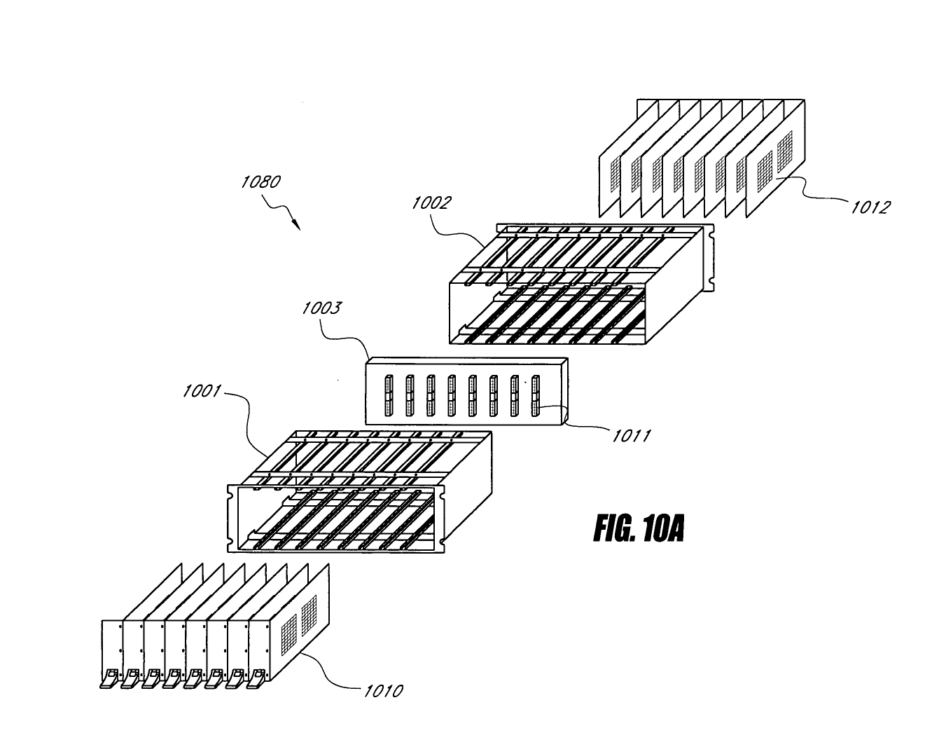

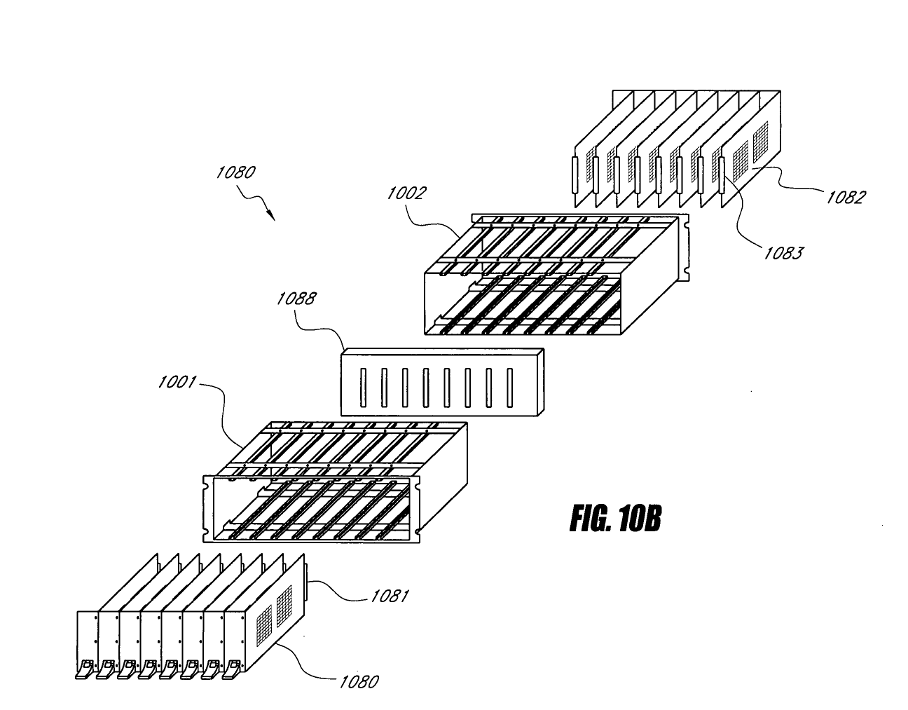

FIG. 10A shows one embodiment of a card mounting arrangement for use in connection with the test system 900 of FIG. 9. In FIG. 10A one or more regenerative load modules are provided to a load card 1010. One or more load cards such as the load card 1010 are provided to a first chassis 1001. The load card 1010 is electrically provided to a load connector 1011 on a backplane 1003. One or more converters under test are provided to a test card 1012. One or more test cards such as the test card 1012 are provided to a second chassis 1002. The test card 1012 is electrically provided to a test connector (not shown) on the backplane 1003. The load connector 1011 and the test connector are on opposite sides of the backplane 1003. The backplane 1003 provides electrical connection and thermal isolation between the load card 1010 and the test card 1012. In one embodiment, the input power 907 and control/monitoring bus 908 shown in FIG. 9 are also provided to the backplane 1003 to allow for easy connection of the input power 907 and bus 908 to the regenerative load modules and/or converters under test.

FIG. 10B shows one embodiment of a card mounting arrangement for use in connection with the test system of FIG. 9 wherein connectors provided to the regenerative loads mate with connectors provided to the converters under test. In FIG. 10B one or more regenerative load modules are provided to a load card 1080. One or more load cards such as the load card 1080 are provided to the first chassis 1001. The load card 1080 includes a connector 1081 that is configured to fit into an opening in a thermal barrier 1088. One or more converters under test are provided to a test card 1082. One or more test cards such as the test card 1082 are provided to the second chassis 1002. A connector 1083 on the test card 1082 is configured to mate with the connector 1081 on the load card 1080.

As shown in FIGS. 10A and 10B, multiple regenerative load modules can be provided to a circuit board or removable module. Similarly, multiple converters to be tested can be provided to a circuit board or removable module. Such modularity allows easy configuration of a testing system for using a relatively large number of regenerative load modules to test a relatively large number of converters. In one embodiment, each regenerative load module is used to test a plurality of converters. In one embodiment, a plurality of regenerative load modules are used to test a single converter. In one embodiment, regenerative load module is used to test a single converter.

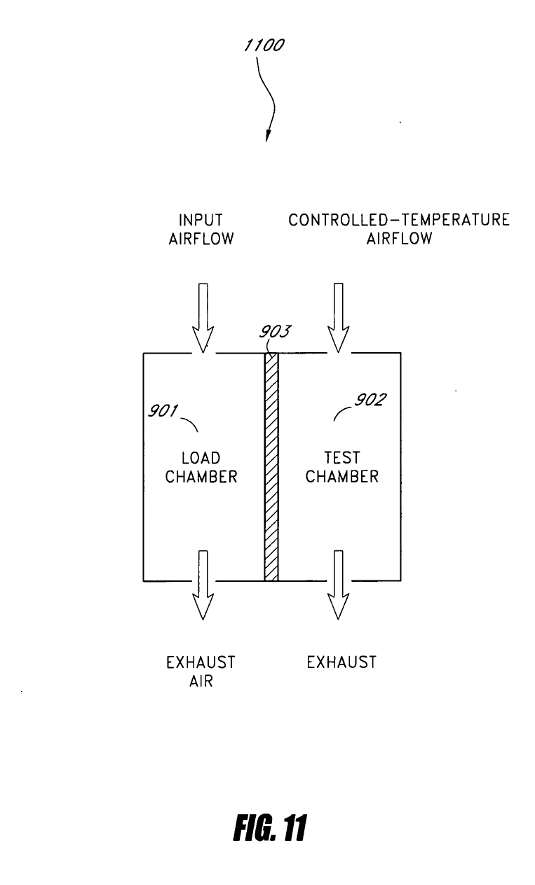

FIG. 11 shows one embodiment of an airflow system 1100 for providing temperature control of the load chamber 901 and the test chamber 902. In the airflow system 1100, load input air at a desired temperature is provided to the load chamber 901 and exhaust air is vented from the load chamber 901. Similarly, test input air at a desired temperature is provided to the test chamber 902 and exhaust air is vented from the test chamber 902. The thermal barrier 903 allows the load chamber 901 to be operated at a different temperature than the test chamber 902. Thus, for example, the load input air provided to the load chamber 901 is typically provided at a temperature needed to operate the regenerative load modules in the load chamber 901 at a desired operating temperature. By contrast, the test input air provided to the test chamber 902 can be heated or cooled as desired to operate the converters under test at various test temperatures

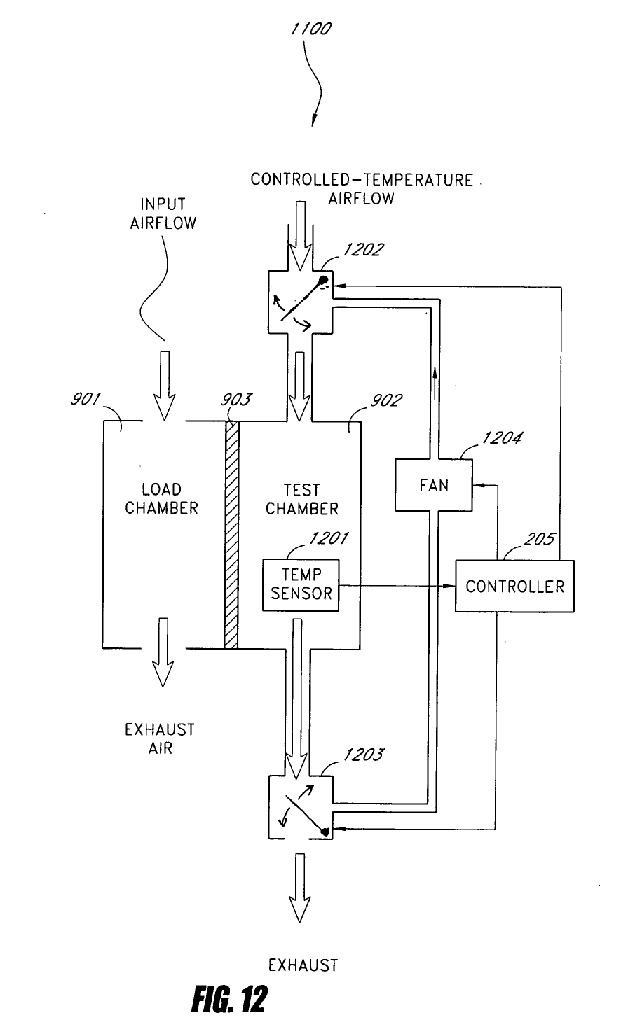

FIG. 12 shows one embodiment of an airflow system 1200 for providing temperature control of the test chamber 902 wherein energy air is re-circulated around the test chamber 902. In the system 1200, air is provided to a first input of a computer-controlled air mixer 1202. An output of the air mixer 1202 is provide to the test chamber 902. Output air from the test chamber 902 is provided to a first input of an air director 1203. A first output of the air director 1203 is provided to an exhaust vent. A second output of the air director 1203 is provided to an input of a fan 1204. An output of the fan 1204 is provided to a second input of the air mixer 1202. The air mixer 1202, the air director 1203 and the fan 1204 are controlled by the controller 205. One or more temperature sensors 1201 in the test chamber 902 are provided to the controller 205.

During testing, it is often desirable to operate the units under test at an elevated temperature. The recirculation system 1200 efficiently allows the heat generated by the units under test to be used to raise the temperature of the test chamber 902, thus, reducing the need for other heating sources and improving the overall energy efficiency of the system. To raise the temperature inside the test chamber 902 during operation of the units under test, the controller can set the air mixer 1202 and the air director 1203 such that the fan 1204 circulates air in the test chamber 902. To cool the test chamber, the controller can shut off the recirculation circuit and set the air mixer 1202 to accept external air (e.g., from ambient air or from an HVAC system) and to exhaust air to the exhaust vent.

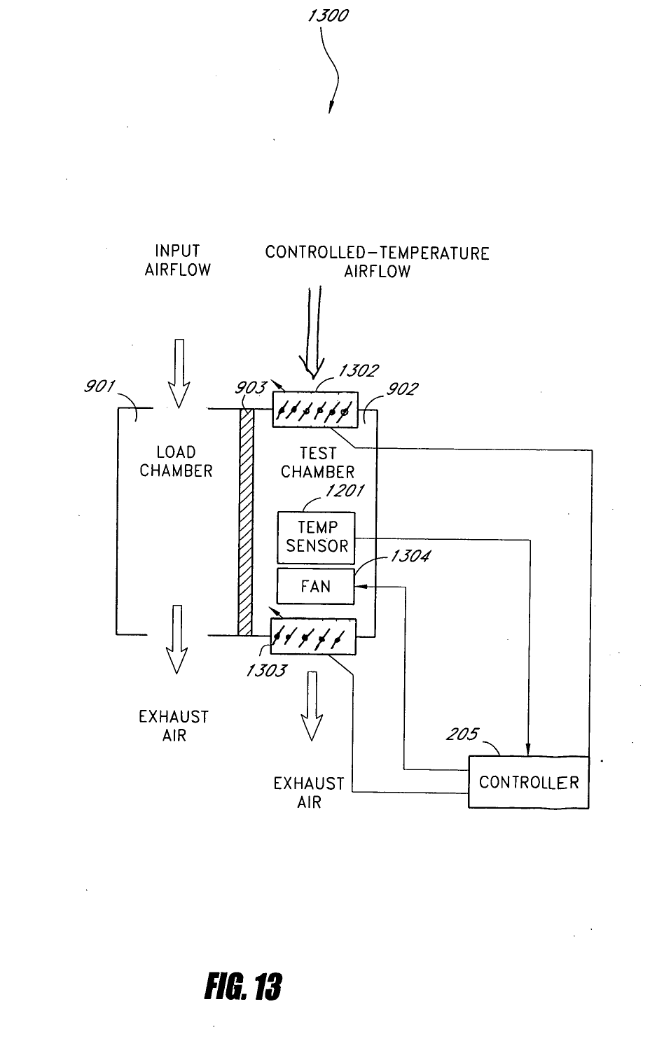

FIG. 13 shows one embodiment of an airflow system 1300 for providing temperature control of a load chamber and a test chamber wherein energy air is re-circulated within the test chamber 902. In the system 1300, air is provided to the test chamber 902 through a computer-controlled input damper 1302. Output air from the test chamber 902 passes through a computer-controlled output damper 1303. A fan 1304 is provided to circulate air within the test chamber 902. One or more temperature sensors 1201 in the test chamber 902 are provided to the controller 205. The controller 205 is provided to the input damper 1302, the output damper 1303, and optionally, to the fan 1304.

To raise the temperature inside the test chamber 902 during operation of the units under test, the controller 205 can close the input damper 1302 and close the output damper 1303. Heat generated by the units under test will then tend to cause the temperature inside the test chamber 902 to rise. To cool the test chamber, the controller can open the input damper 1302 and open the output damper 1303.

Although various embodiments have been described above, other embodiments will be within the skill of one of ordinary skill in the art. Thus, the invention is limited only by the claims.

What is claimed is:

1. A regenerative load, comprising:
an input configured to draw a specified current; and
an output configured to provide an output voltage and current, said regenerative load configured to maintain said output voltage to cause said regenerative load to draw said specified current.

2. The regenerative load of claim 1, wherein said input current is substantially direct current.

3. The regenerative load of claim 1, wherein said output current is substantially direct current.

4. The regenerative load of claim 1, further comprising a command input configured to receive commands.

5. The regenerative load of claim 1, wherein said further specified current is programmable.

6. The regenerative load of claim 1, wherein said regenerative load operates at a power efficiency of at least 80 percent.

7. The regenerative load of claim 1, wherein said output voltage is limited to an upper limit.

8. The regenerative load of claim 7, wherein said upper limit is programmable.

9. The regenerative load of claim 1, further comprising a second input configured to draw a specified second current.

10. The regenerative load of claim 1, further comprising a second input configured to draw a specified second current, where a voltage at said second input is independent of a voltage at said input.

11. The regenerative load of claim 1, wherein an input voltage at said input is relatively lower than said output voltage.

12. The regenerative load of claim 1, wherein an input voltage at said input is relatively higher than said output voltage.

13. The regenerative load of claim 1, wherein said input is DC-isolated from said output.

14. A regenerative load system, comprising:
a first regenerative load configured to draw a first specified current from a first output of a power converter and to provide power from said first output to an input of said power converter; and
a second regenerative load configured to draw a second specified current from a second output of said power converter and to provide power from said second output to said input of said power converter.

15. A test system comprising:
a plurality of regenerative load modules;
a plurality of units under test provided to said regenerative load modules;
a thermal barrier between said plurality of regenerative load modules and said plurality of units under test;
a control bus provided to said plurality of regenerative load modules; and
a controller provided to said control bus and configured to control said plurality of regenerative load modules.

16. The test system of claim 15, further comprising a temperature sensor provided to measure an air temperature in a test chamber containing said units under test, said controller further configured to control said air temperature.

17. The test system of claim 15, wherein said controller is configured to control said air temperature at least in part by controlling recirculation of air in said test chamber.
